(19) United States
(12) Patent Application Publication
(10) Pub. No.: US 2026/0125923 A1
(43) Pub. Date: May 7, 2026

(54) FOLDABLE CAR ROOF TENT BRACKET AND FOLDABLE CAR ROOF TENT

(71) Applicant: NINGBO ALL-TOP AUTO PRODUCTS CO., LIMITED, Ningbo (CN)

(72) Inventor: Fen XIE, Ningbo (CN)

(21) Appl. No.: 19/023,837

(22) Filed: Jan. 16, 2025

(30) Foreign Application Priority Data
Nov. 4, 2024 (CN) 2024226804713

(51) Int. Cl. E04H 15/06; B60R 3/02

(52) U.S. Cl. CPC E04H 15/06; B60R 3/02

(57) ABSTRACT

Provided is a foldable car roof tent bracket, including: a tent bracket body, a supporting frame and a tent cloth, wherein the tent bracket body includes a first base, a second base, a third base and supporting connecting rods. When the third base and the supporting frame are rotated and stored in a receiving cavity formed by the first base and the second base, the entire tent bracket body occupies the smallest space and is easy to carry. When the first base and the second base are unfolded, the third base and the supporting frame are rotated to extend outward to increase the space occupied by the entire car roof tent bracket, and first housings and first rods of the supporting connecting rods are extended to support the first base, thereby providing sufficient safety and comfort for users.

### BACKGROUND OF THE INVENTION

### 1. Technical Field

The present invention belongs to the technical field of tents and relates to a foldable car roof tent bracket and a foldable car roof tent.

### 2. Description of Related Art

With the continuous growth of private car ownership, self-driving tours have become a new way of travel. In order to improve the convenience and comfort of self-driving travel, various vehicle-mounted supporting products have emerged and developed rapidly. Car tents are one of them. This type of product has been innovated and developed in the context of meeting people's growing demand for self-driving tours.

Although some existing technical solutions have solved the problems of storing and carrying car tents, most of the conventional car tents have limited internal space and still have much room for improvement for individuals with taller heights or families thereof.

### BRIEF SUMMARY OF THE INVENTION

In view of the problems existing in the prior art, an objective of the present invention is to provide a foldable car roof tent bracket, including:
a tent bracket body, including a first base, a second base, a third base and supporting connecting rods, wherein one end of the first base is rotatably connected to one end of the second base, one end of the third base is rotatably connected to the other end of the second base, each of the supporting connecting rods includes a first housing and a first rod, the first rod is telescopically connected to the first housing, one ends of the first housing and the first rod are rotatably connected to the first base, and the other ends of the first housing and the first rod are rotatably connected to the second base; and
a supporting frame, having two ends rotatably connected to the second base; wherein when the first base and the second base are folded to form a receiving cavity and the third base and the supporting frame are rotated to be received in the receiving cavity, the foldable car roof tent bracket is in a folded state; when the first base and the second base are unfolded and the third base and the supporting frame are rotated to the other side away from the first base, the foldable car roof tent bracket is in an unfolded state.

In the foldable car roof tent bracket described above, each of the first housings is provided with a driving element, and the driving elements drive the first housings and the first rods to move away from each other.

In the foldable car roof tent bracket described above, the second base is provided with a first limiting portion, and the third base is provided with a second limiting portion;
when the foldable car roof tent is in the unfolded state, the first limiting portion contacts the second limiting portion.

The foldable car roof tent bracket described above further includes a flipping limiter, wherein the flipping limiter is provided at one end of the second base close to the third base and is rotatably connected to the second base, the second base is provided with a first contact surface, the flipping limiter is provided with a second contact surface and a third contact surface, and the third base is provided with a fourth contact surface;
when the foldable car roof tent is in the unfolded state, the first contact surface contacts the second contact surface, and the fourth contact surface contacts the third contact surface.

In the foldable car roof tent bracket described above, the second base is also provided with a waterproof side edge, and when the first base and the second base are folded, the waterproof side edge contacts the first base.

In the foldable car roof tent bracket described above, the second base is also provided with a first waterproof portion, and the flipping limiter is provided with a second waterproof portion, and when the flipping limiter is folded, the first waterproof portion contacts the second waterproof portion.

In the foldable car roof tent bracket described above, the first waterproof portion is configured as a sealing waterproof strip, and the sealing waterproof strip is provided on the second base and tightly fitted with the second waterproof portion.

The foldable car roof tent bracket described above further includes a folding ladder having one end rotatably connected to the second base.

In the foldable car roof tent bracket described above, a supporting frame is provided at one end of the third base away from the second base.

In the foldable car roof tent bracket described above, the supporting frame includes a supporting horizontal rod and two supporting vertical rods, one end of the supporting horizontal rod is connected to one end of one of the supporting vertical rods, the other end of the supporting horizontal rod is connected to one end of the other supporting vertical rod, and the other ends of the two supporting vertical rods are rotatably connected to the second base or the third base.

In the foldable car roof tent bracket described above, each of the supporting vertical rods includes a second housing, a second rod and a fixing clip, and the second rod is received in the second housing and is slidably connected to the second housing by the fixing clip.

Secondly, a foldable car roof tent, including the described foldable car roof tent bracket, and further including: a tent cloth, the tent cloth being connected to the first base, the second base and the third base.

In the foldable car roof tent described above, the supporting frame includes a supporting horizontal rod and two supporting vertical rods, one end of the supporting horizontal rod is connected to one end of one of the supporting vertical rods, the other end of the supporting horizontal rod is connected to one end of the other supporting vertical rod, the other ends of the two supporting vertical rods are rotatably connected to one end of the first base close to the third base, and the supporting horizontal rod is connected to the tent cloth.

Compared with the prior art, the beneficial effects of the present invention are as follows:
1. When the third base and the supporting frame are rotated and stored in the receiving cavity formed by the first base and the second base, the entire tent bracket body occupies the smallest space and is easy to carry. When the first base and the second base are unfolded, the third base and the supporting frame are rotated to extend outward to increase the space occupied by the entire car roof tent bracket, and the first housings and first rods of the supporting connecting rods are extended to support the first base, thereby providing sufficient safety and comfort for users.
2. The driving elements can provide a stable support for the first base in the unfolded state to ensure the firmness and safety of the entire structure. Moreover, when the first base is folded, due to the rotating connection between the first base and the second base, a certain angle can be formed between the first base and the second base. In this case, by the design of the driving elements, the first base can be folded very easily along this angle. This design not only simplifies the folding process and reduces the complexity of the operation, but more importantly, it greatly reduces the physical exertion required by the user during the folding process. It means that even users with less strength can easily complete the folding of the car roof tent bracket, thereby improving the practicality and user experience of the product.
3. The third base is flipped out from a storage position in the folded state. As the third base flips, the third base will gradually move away from the first base until the second limiting portion on the third base contacts the first limiting portion on the second base. This step indicates that the third base reaches the final unfolded position thereof, and also means that the second base and the third base are correctly aligned and are now located on the same horizontal plane to form a continuous and stable support surface, thereby providing a safer and more comfortable resting environment for the user.
4. By vertically arranging the waterproof side edge on the second base and ensuring that the waterproof side edge can be in close contact with the first base and perfectly received in the side edge of the first base in the folded state, it significantly improves the waterproof performance of the foldable car roof tent bracket and also facilitates reducing the external size of the entire foldable car roof tent bracket, thereby improving portability and aesthetics, and ensuring that the waterproof side edge is not damaged by external collision during transportation or storage.
5. The sealing waterproof strips are made of a soft and elastic material, such as rubber or silicone, to ensure that the sealing waterproof strips can fit tightly under pressure without hindering the normal movement of the flipping limiter. In addition, in order to improve the waterproof level, a labyrinth structure may be designed on the contact surface between the sealing waterproof strip and the second waterproof portion, thereby providing better sealing performance for the interior of the foldable car roof tent bracket.

### BRIEF DESCRIPTION OF THE SEVERAL VIEWS OF THE DRAWINGS

FIG. 1 is a schematic structural diagram of the present invention.

FIG. 2 is a schematic structural diagram of another embodiment according to the present invention.

FIG. 3 is an enlarged view of detail A in FIG. 2.

FIG. 4 is a side view of the present invention.

FIG. 5 is an enlarged view of detail B in FIG. 4.

FIG. 6 is another marking pattern of FIG. 5.

FIG. 7 is a bottom view of the present invention.

In the figures,

1. tent bracket body; 11. first base; 12. second base; 121. First limiting portion; 122. first contact surface; 123. waterproof side edge; 124. first waterproof portion; 13. third base; 131. second limiting portion; 132. fourth contact surface; 14, supporting connecting rod; 141, first housing; 142, first rod; 2, supporting frame; 21, supporting horizontal rod; 22, supporting vertical rod; 221, second housing; 222, second rod; 223. fixing clip; 3. flipping limiter; 31. second contact surface; 32. third contact surface; 33. second waterproof portion; 4. folding ladder.

### DETAILED DESCRIPTION OF THE INVENTION

The following are specific embodiments of the invention to further describe the technical solution of the invention in conjunction with the accompanying drawings, but the invention is not limited to these embodiments.

It should be noted that all directional indications in the embodiments of the invention (such as upper, lower, left, right, front, and back) are only used to explain the relative position relationship, movement, etc. between the components under a certain posture (as shown in the accompanying drawings). If the specific posture changes, the directional indications will also change accordingly.

In addition, in the invention, the descriptions such as “first”, “second”, and “one”, are only used for descriptive purposes, and should not be construed as indicating or implying their relative importance or implicitly indicating the number of technical features indicated. Therefore, the features defined as “first” or “second” may explicitly or implicitly include at least one of the features. As used herein, “a plurality of” means at least two, such as two, three, etc., unless otherwise clearly and specifically defined.

As used herein, unless otherwise clearly specified and defined, the terms “connect”, “fix”, etc. should be understood in a broad sense. For example, “fix” may be a fixed connection, a detachable connection, or an integral connection; it may be a mechanical connection or an electrical connection; it may be a direct connection or an indirect connection by means of an intermediate medium. it may be the internal connection of two elements or the interaction relationship between two elements, unless otherwise clearly defined. Those of ordinary skill in the art can understand the specific meanings of the above terms in the invention according to specific circumstances.

In addition, the technical solutions of the various embodiments of the invention can be combined, but it must be based on the fact that those of ordinary skill in the art can implement it. When the combination of technical solutions is contradictory or cannot be achieved, it should be considered that such a combination of technical solutions does not exist and is not within the scope of the invention.

The specific embodiments described herein are merely examples of the invention. Those skilled in the technical field to which the invention belongs can make various modifications or supplements to the described specific embodiments or replace them in a similar way, without departing from the patent of the invention or going beyond the scope defined by the appended claims.

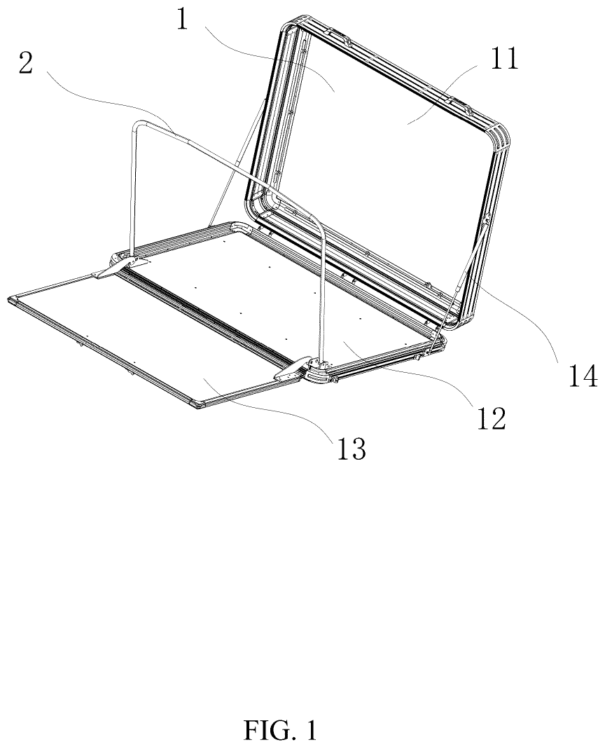

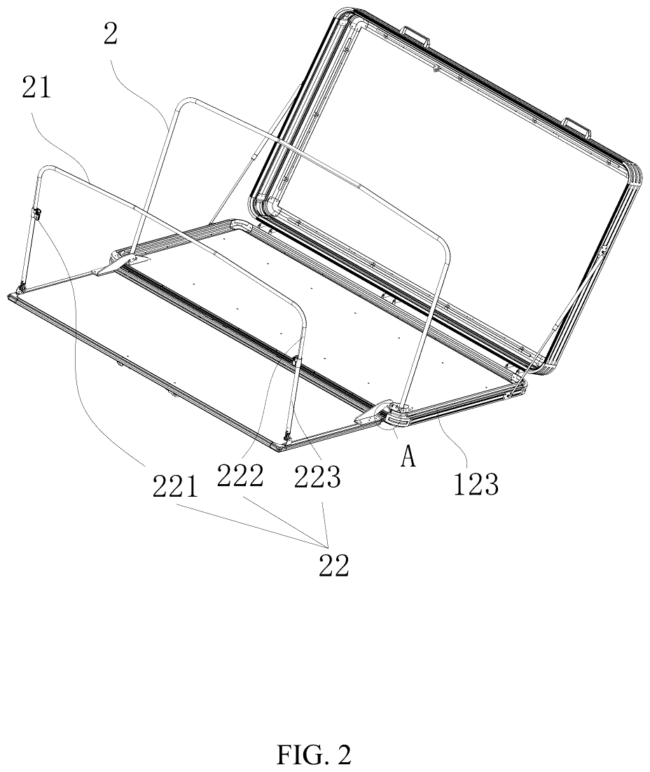

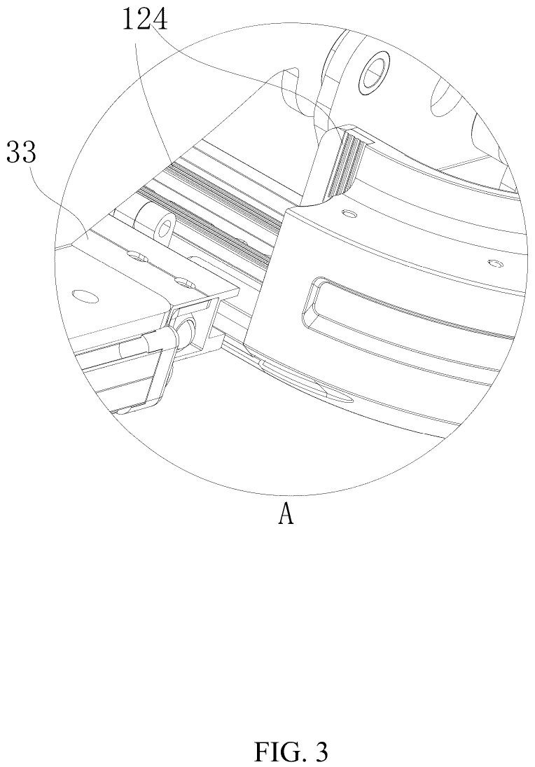

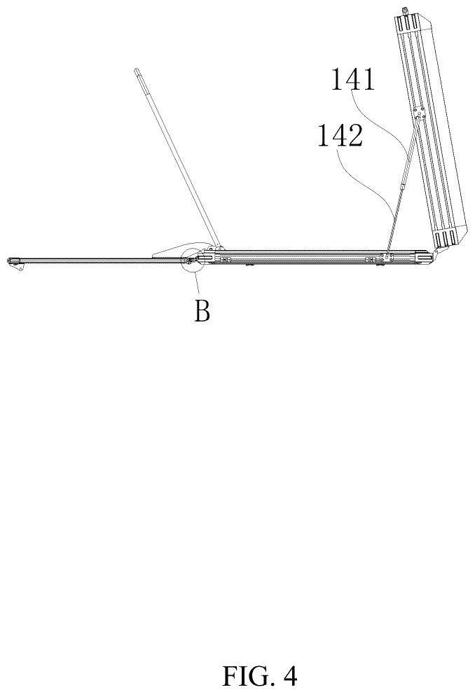

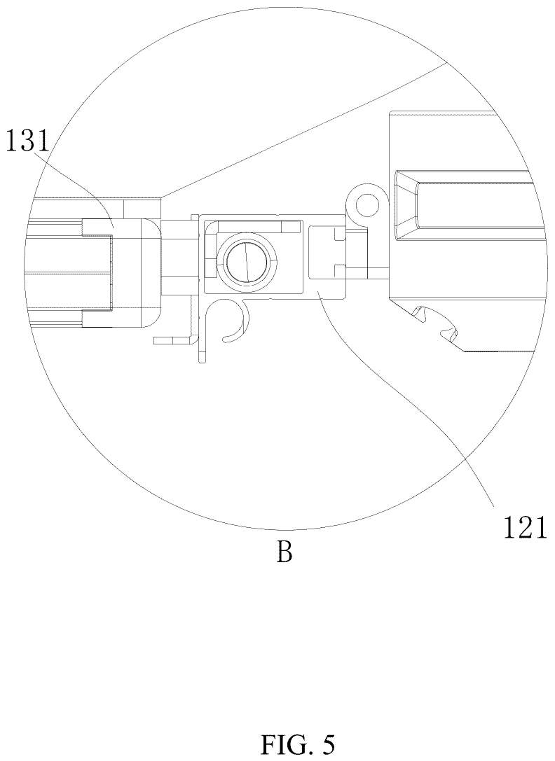

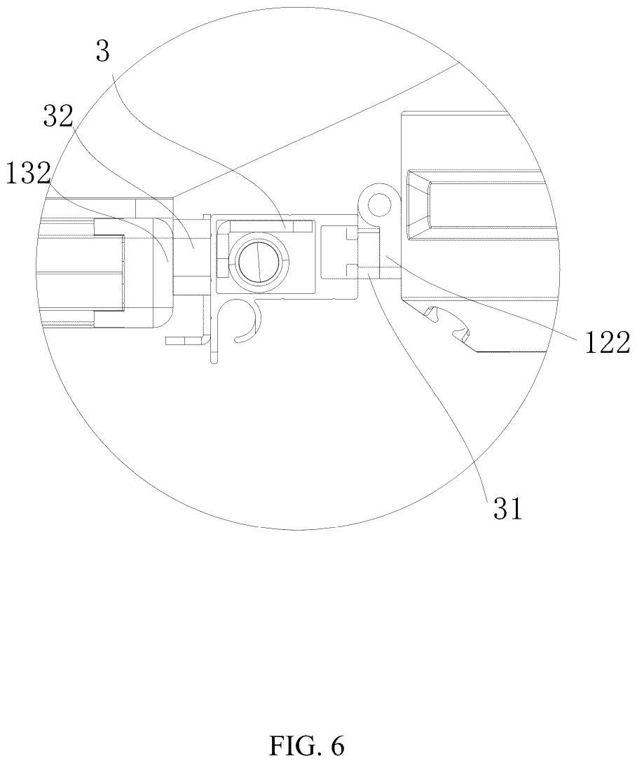

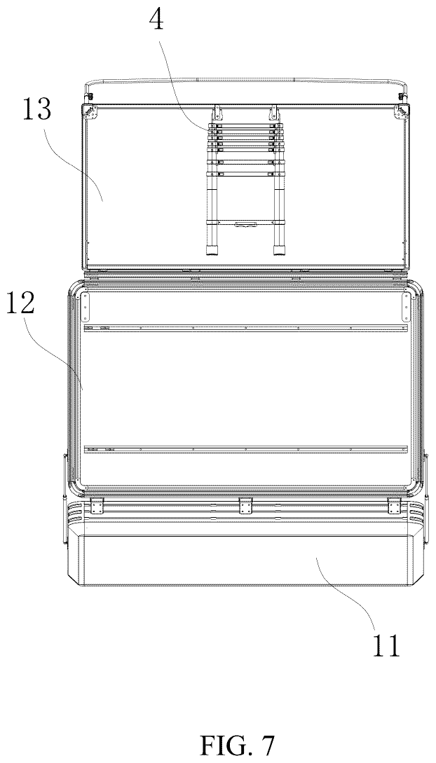

As shown in FIGS. 1-7, provided is a foldable car roof tent bracket, including a tent bracket body 1 and a supporting frame 2.

The tent bracket body 1 includes a first base 11, a second base 12, a third base 13 and supporting connecting rods 14, wherein one end of the first base 11 is rotatably connected to one end of the second base 12, one end of the third base 13 is rotatably connected to the other end of the second base 12, each of the supporting connecting rods 14 includes a first housing 141 and a first rod 142, the first rod 142 is telescopically connected to the first housing 141, one ends of the first housing 141 and the first rod 142 are rotatably connected to the first base 11, and the other ends of the first housing 141 and the first rod 142 are rotatably connected to the second base 12.

The supporting frame 2 have two ends rotatably connected to the second base 12.

In a specific embodiment, when the first base 11 and the second base 12 are folded to form a receiving cavity (not shown) and the third base 13 and the supporting frame 2 are rotated to be received in the receiving cavity, the foldable car roof tent bracket is in a folded state; when the first base 11 and the second base 12 are unfolded and the third base 13 and the supporting frame 2 are rotated to the other side away from the first base 11, the foldable car roof tent bracket is in an unfolded state.

In this embodiment, when the third base 13 and the supporting frame 2 are rotated and stored in the receiving cavity formed by the first base 11 and the second base 12, the entire tent bracket body occupies the smallest space and is easy to carry. When the first base 11 and the second base 12 are unfolded, the third base 13 and the supporting frame 2 are rotated to extend outward to increase the space occupied by the entire car roof tent bracket, and the first housings 141 and first rods 142 of the supporting connecting rods 14 are extended to support the first base 11, thereby providing sufficient safety and comfort for users.

As shown in FIGS. 1-7, based on the above embodiment, each of the first housings 141 is provided with a driving element (not shown), and the driving elements drive the first housings 141 and the first rods 142 to move away from each other.

In a specific embodiment, the driving elements may be elastic members, compressed gas or the like. When the first base 11 and the second base 12 are unfolded to a certain angle, the driving elements automatically drive the first housings 141 and the first rods 142 to move away from each other and continuously provide supporting force, so that the first base 11 is unfolded and held at a certain angle. When the foldable car roof tent bracket is ready to be folded, one end of the first base 11 is pressed down, and the first housings 141 and the first rods 142 are compressed together due to the great pressure, and finally the first base 11 and the second base 12 are folded.

In this embodiment, the driving elements can provide a stable support for the first base 11 in the unfolded state to ensure the firmness and safety of the entire structure. Moreover, when the first base 11 is folded, due to the rotating connection between the first base 11 and the second base 12, a certain angle can be formed between the first base 11 and the second base 12. In this case, by the design of the driving elements, the first base 11 can be folded very easily along this angle. This design not only simplifies the folding process and reduces the complexity of the operation, but more importantly, it greatly reduces the physical exertion required by the user during the folding process. It means that even users with less strength can easily complete the folding of the car roof tent bracket, thereby improving the practicality and user experience of the product.

As shown in FIGS. 1-7, based on the above embodiment, the second base 12 is provided with a first limiting portion 121, and the third base 13 is provided with a second limiting portion 131; when the foldable car roof tent is in the unfolded state, the first limiting portion 121 contacts the second limiting portion 131.

In a specific embodiment, when the foldable roof tent bracket is unfolded, the third base 13 is flipped until the second limiting portion 131 on the third base 13 contacts the first limiting portion 121 on the second base 12 and in this case, the third base 13 and the second base 12 are both on the same plane.

In a specific embodiment, the third base 13 is flipped out from a storage position in the folded state. As the third base 13 flips, the third base 13 will gradually move away from the first base 11 until the second limiting portion 131 on the third base 13 contacts the first limiting portion 121 on the second base 12. This step indicates that the third base 13 reaches the final unfolded position thereof, and also means that the second base 12 and the third base 13 are correctly aligned and are now located on the same horizontal plane to form a continuous and stable support surface, thereby providing a safer and more comfortable resting environment for the user.

As shown in FIGS. 1-7, based on the above embodiment, the foldable car roof tent bracket further includes a flipping limiter 3, wherein the flipping limiter 3 is provided at one end of the second base 12 close to the third base 13 and is rotatably connected to the second base 12, the second base 12 is provided with a first contact surface 122, the flipping limiter 3 is provided with a second contact surface 31 and a third contact surface 32, and the third base 13 is provided with a fourth contact surface 132; when the foldable car roof tent is in the unfolded state, the first contact surface 122 contacts the second contact surface 31, and the fourth contact surface 132 contacts the third contact surface 32.

In a specific embodiment, when the foldable car roof tent bracket is unfolded, the flipping limiter 3 is flipped first, and the second contact surface 31 on the flipping limiter 3 contacts the first contact surface 122 on the second base 12, so that the flipping limiter 3 and the second base 12 are on the same plane, and then the third base 13 is flipped until the fourth contact surface 132 on the third base 13 contacts the third contact surface 32 on the flipping limiter 3 and in this case, the third base 13, the flipping limiter 3 and the second base 12 are all on the same plane.

In this embodiment, the flipping limiter 3 can make the third base 13 and the second base 12 on the same horizontal plane, forming a continuous and stable support surface. Moreover, as a connecting member between the third base 13 and the second base 12, the flipping limiter 3 can also play a buffering role, reduce the risk of damage caused by improper use, and increase the service life of the second base 12 and the third base 13. In addition, the flipping limiter 3 has the advantage of convenient replacement and can be replaced timely when worn.

As shown in FIGS. 1-7, based on the above embodiment, the second base 12 is also provided with a waterproof side edge 123, and when the first base 11 and the second base 12 are folded, the waterproof side edge 123 contacts the first base 11.

In a specific embodiment, the waterproof side edge 123 is vertically arranged on the second base 12, and when the foldable car roof tent bracket is in a folded state, the waterproof side edge 123 can be creatively received inside the side edge of the first base 11 or fit the side edge of the first base 11 along the contour of the side edge.

In this embodiment, by vertically arranging the waterproof side edge 123 on the second base 12 and ensuring that the waterproof side edge 123 can be in close contact with the first base 11 and perfectly received in the side edge of the first base 11 in the folded state, it significantly improves the waterproof performance of the foldable car roof tent bracket and also facilitates reducing the external size of the entire foldable car roof tent bracket, thereby improving portability and aesthetics, and ensuring that the waterproof side edge 123 is not damaged by external collision during transportation or storage.

As shown in FIGS. 1-7, based on the above embodiment, the second base 12 is also provided with a first waterproof portion 124, and the flipping limiter 3 is provided with a second waterproof portion 33, and when the flipping limiter 3 is folded, the first waterproof portion 124 contacts the second waterproof portion 33.

In this embodiment, when the flip limiter 3 is folded, the second waterproof portion 33 accurately contacts the first waterproof portion 124 on the second base 12 to form an effective sealing interface. This design can prevent moisture from penetrating into the interior of the device via a gap between the two waterproof portions, and also ensure that a good waterproof effect is maintained during frequent operations without affecting the original limiting function.

As shown in FIGS. 1-7, based on the above embodiment, the first waterproof portion 124 is configured as a sealing waterproof strip, and the sealing waterproof strip is provided on the second base 12 and tightly fitted with the second waterproof portion 33.

In this embodiment, the sealing waterproof strips are made of a soft and elastic material, such as rubber or silicone, to ensure that the sealing waterproof strips can fit tightly under pressure without hindering the normal movement of the flipping limiter 3. In addition, in order to improve the waterproof level, a labyrinth structure may be designed on the contact surface between the sealing waterproof strip and the second waterproof portion 33, thereby providing better sealing performance for the interior of the foldable car roof tent bracket.

As shown in FIGS. 1-7, based on the above embodiment, the foldable car roof tent bracket further includes a folding ladder 4 having one end rotatably connected to the second base 12.

In a specific embodiment, the folding ladder 4 is telescopically foldable, is rotatably connected to the second base 12 and can be folded and stored at the bottom of the second base 12.

In this embodiment, when the foldable car roof tent bracket is set up on a car roof, the folding ladder 4 can be adjusted to extend out of a car, and by adjusting the length of the folding ladder 4, the folding ladder 4 is ensured to be stable and reliable and also can adapt to cars of different heights. In this way, it is more easy and safer for the user to go up to the car roof to enter a tent or gets off the car and returns to the ground, thereby avoiding the danger that may be caused by direct climbing the car.

As shown in FIGS. 1-7, based on the above embodiment, the supporting frame 2 is provided at one end of the third base 13 away from the second base 12.

In this embodiment, a supporting frame 2 is also provided on the third base 13 to increase the internal space formed and supported by the entire car roof tent bracket, thereby further improving the comfort of the user.

As shown in FIGS. 1-7, based on the above embodiment, the supporting frame 2 includes a supporting horizontal rod 21 and two supporting vertical rods 22, one end of the supporting horizontal rod 21 is connected to one end of one of the supporting vertical rods 22, the other end of the supporting horizontal rod 21 is connected to one end of the other supporting vertical rod 22, and the other ends of the two supporting vertical rods 22 are rotatably connected to the second base 12 or the third base 13.

In this embodiment, the structure jointly formed by the supporting horizontal rod 21 and the two supporting vertical rods 22 enhances the structural strength and stability of the entire supporting frame 2. Moreover, the overall structure of the supporting frame 2 is similar to the structure of the first base 11 and the second base 12. On the basis that the supporting frame 2 can be received in the receiving cavity formed by the first base 11 and the second base 12, the supporting frame 2 also can increase the internal space formed and supported by the car roof tent bracket as much as possible to ensure that the user can enjoy sufficient space for rest.

As shown in FIGS. 1-7, based on the above embodiment, each of the supporting vertical rods includes a second housing 221, a second rod 222 and a fixing clip 223, and the second rod 222 is received in the second housing 221 and is slidably connected to the second housing 221 by the fixing clip 223.

In a specific embodiment, the second rod 222 is received in the second housing 221 and is slidably connected to the second housing 221, and the fixing clip 223 is configured to fix the height of the second rod 222 in the second housing 221.

In this embodiment, this design allows the second rod 222 to be telescopically adjusted according to actual needs, thereby adjusting the total length of the corresponding supporting vertical rod 22. When the bracket needs to be unfolded, the second rod 222 is slid and then locked in a desired position using the fixing clip 223, thus achieving an ideal support height. When the bracket needs to be folded, the fixing clip 223 is loosened to retract the second rod 222 into the second housing 221, so that the entire supporting vertical rod 22 becomes more compact and easier to carry and store. This adjustable design improves the flexibility and adaptability of the bracket.

As shown in FIGS. 1-7, provided is a foldable car roof tent, including the described foldable car roof tent bracket, and further including: a tent cloth (not shown), the tent cloth being connected to the first base 11, the second base 12 and the third base 13.

In this embodiment, the tent cloth is directly connected to the first base 11, the second base 12 and the third base 13. As a result, when the foldable car roof tent is unfolded, the tent cloth automatically opens as these bases are unfolded to form a complete tent structure. This integrated design not only simplifies the setup procedures, but also improves the setup speed, thereby ensuring that users can quickly obtain a safe shelter in an emergency. In addition, this design also reduces the risk of component damage caused by frequent splicing, increases the service life of the tent, and improves the overall user experience.

As shown in FIGS. 1-7, based on the above embodiment, the supporting frame 2 includes a supporting horizontal rod 21 and two supporting vertical rods 22, one end of the supporting horizontal rod 21 is connected to one end of one of the supporting vertical rods 22, the other end of the supporting horizontal rod 21 is connected to one end of the other supporting vertical rod 22, the other ends of the two supporting vertical rods 22 are rotatably connected to one end of the first base 11 close to the third base 13, and the supporting horizontal rod 21 is connected to the tent cloth.

In this embodiment, the supporting horizontal rod 21 on the supporting frame 2 is also directly connected to the tent cloth. When the foldable car roof tent is unfolded, the supporting horizontal rod 21 is automatically adjusted to a preset position as the tent cloth opens, thereby ensuring the stability and integrity of the entire tent structure. This design also reduces potential errors and inconveniences caused by manual adjustment of the supporting frame 2, thereby further improving the user experience and the reliability of the tent.

What is claimed is:

1. A foldable car roof tent bracket, characterized by, comprising:
a tent bracket body, comprising a first base, a second base, a third base and supporting connecting rods, wherein one end of the first base is rotatably connected to one end of the second base, one end of the third base is rotatably connected to the other end of the second base, each of the supporting connecting rods comprises a first housing and a first rod, the first rod is telescopically connected to the first housing, one ends of the first housing and the first rod are rotatably connected to the first base, and the other ends of the first housing and the first rod are rotatably connected to the second base; and
a supporting frame have two ends rotatably connected to the second base; wherein
when the first base and the second base are folded to form a receiving cavity and the third base and the supporting frame are rotated to be received in the receiving cavity, the foldable car roof tent bracket is in a folded state; when the first base and the second base are unfolded and the third base and the supporting frame are rotated to the other side away from the first base, the foldable car roof tent bracket is in an unfolded state.

2. The foldable car roof tent bracket according to claim 1, characterized in that, each of the first housings is provided with a driving element, and the driving elements drive the first housings and the first rods to move away from each other.

3. The foldable car roof tent bracket according to claim 1, characterized in that, the second base is provided with a first limiting portion, and the third base is provided with a second limiting portion;
when the foldable car roof tent is in the unfolded state, the first limiting portion contacts the second limiting portion.

4. The foldable car roof tent bracket according to claim 3, characterized by, further comprising a flipping limiter, wherein the flipping limiter is provided at one end of the second base close to the third base and is rotatably connected to the second base, the second base is provided with a first contact surface, the flipping limiter is provided with a second contact surface and a third contact surface, and the third base is provided with a fourth contact surface;
when the foldable car roof tent is in the unfolded state, the first contact surface contacts the second contact surface, and the fourth contact surface contacts the third contact surface.

5. The foldable car roof tent bracket according to claim 4, characterized in that, the second base is also provided with a waterproof side edge, and when the first base and the second base are folded, the waterproof side edge contacts the first base.

6. The foldable car roof tent bracket according to claim 5, characterized in that, the second base is also provided with a first waterproof portion, and the flipping limiter is provided with a second waterproof portion, and when the flipping limiter is folded, the first waterproof portion contacts the second waterproof portion.

7. The foldable car roof tent bracket according to claim 6, characterized in that, the first waterproof portion is configured as a sealing waterproof strip, and the sealing waterproof strip is provided on the second base and tightly fitted with the second waterproof portion.

8. The foldable car roof tent bracket according to claim 1, characterized by, further comprising a folding ladder having one end rotatably connected to the second base.

9. The foldable car roof tent bracket according to claim 1, characterized in that, a supporting frame is provided at one end of the third base away from the second base.

10. The foldable car roof tent bracket according to claim 9, characterized in that, the supporting frame comprises a supporting horizontal rod and two supporting vertical rods, one end of the supporting horizontal rod is connected to one end of one of the supporting vertical rods, the other end of the supporting horizontal rod is connected to one end of the other supporting vertical rod, and the other ends of the two supporting vertical rods are rotatably connected to the second base or the third base.

11. The foldable car roof tent bracket according to claim 10, characterized in that, each of the supporting vertical rods comprises a second housing, a second rod and a fixing clip, and the second rod is received in the second housing and is slidably connected to the second housing by the fixing clip.

12. A foldable car roof tent, characterized by, comprising: the foldable car roof tent bracket according to claim 1, and further comprising:
a tent cloth, the tent cloth being connected to the first base, the second base and the third base.

13. The foldable car roof tent according to claim 12, characterized in that, the supporting frame comprises a supporting horizontal rod and two supporting vertical rods, one end of the supporting horizontal rod is connected to one end of one of the supporting vertical rods, the other end of the supporting horizontal rod is connected to one end of the other supporting vertical rod, the other ends of the two supporting vertical rods are rotatably connected to one end of the first base close to the third base, and the supporting horizontal rod is connected to the tent cloth.
